(19) United States
(12) Patent Application Publication
(10) Pub. No.: US 2010/0091206 A1
(43) Pub. Date: Apr. 15, 2010

(54) MULTI-VIEW STEREOSCOPIC DISPLAY

(75) Inventor: John Chapman, North Perth, W.A. (AU)

Correspondence Address: BROOKS KUSHMAN P.C., 1000 TOWN CENTER, TWENTY-SECOND FLOOR, SOUTHFIELD, MI, 48075, US

(73) Assignee: VR21 PTY LTD, Toorak, VIC (AU)

(21) Appl. No.: 12/524,053

(22) PCT Filed: Feb. 6, 2008
(86) PCT No.: PCT/AU08/00152

§ 371 Date: Jul. 22, 2009

(30) Foreign Application Priority Data
Feb. 7, 2007 (AU) 2007900581

(51) Int. Cl. G02F 1/1335; H04N 13/04

(52) U.S. Cl. 349/15

(57) ABSTRACT

An auto-stereoscopic display which delivers a 3D sensation by coupling a lenticular lens to an LCD display, the lens axis inclined at an angle to the vertical of the display, with the output from each alternate row of pixels repeated on the row or rows immediately above each row, the auto-stereoscopic display delivering repeating sets of a multiple of nine views.

### FIELD OF INVENTION

This invention relates to auto-stereoscopic displays whereby a lenticular lens is placed between a flat-panel display and an observer in order to generate a perceived three-dimensional impression.

### BACKGROUND

To increase the visual experience of a viewer observing two-dimensional images it has been recognised that introducing a perceived third dimension is one successful method. This effect has been used for advertising signage and visual promotional campaigns. In the entertainment industry, a perceived three-dimensional viewing was achieved for many years using coloured filter glasses and later by using shutter glasses synchronised with a display that alternated between left and right eye views.

The advent of flat panel displays such as the liquid crystal (LCD) and plasma varieties heralded the possibility of interposing an optical element between the display and the viewer to present a different image to each eye of a viewer.

To achieve these different images, an image is split into a multitude of views corresponding to different viewing angles. These views are spliced into an image and an array of cylindrical lens focuses each view into different directions. The angular separation between adjacent views is designed such that within a specified viewing distance from a display, each eye of an observer receives light from a different view. Various literature describes the principles and technology, for example with U.S. Pat. No. 6,064,424. The simplest arrangements only produce two views, while multi-view systems have typically between seven and nine views, with the sets of views repeating as an observer moves sideways. At the transition between the sets of views the image seen by an observer's eyes are unmatched and the 3D effect is lost and the experience is uncomfortable.

Higher numbers of views provide an increased 3D experience as objects can be ‘looked around’ to a greater degree and also the number of transitions at which a set of views repeats is reduced. The resistance to increasing the number of views is the loss of horizontal resolution and the disparity between horizontal and vertical resolutions.

Another relevant issue with displays featuring lenticular lens is the production of Moiré patterns. These are most pronounced when the axis of the lenticles passes through the non-light emitting intersections between sub-pixels, and manifests itself by dark bands that pass across the screen as an observer moves sideways. Moiré patterns are very conspicuous with nine-view systems for which the lenticle axes pass diagonally through each sub-pixel from corner to opposite corner intersecting the maximum number of non-light emitting intersections.

Recent developments with LCD technology are producing high definition displays which exceed 2000 pixels in a horizontal direction, and approach 4000 pixels. Prior to the advent of these ultra-high definition displays, the highest commercially available definition was 1920×1080 pixels which limited the quantity of effective views to a maximum of about nine, which coincides with the optimum configuration of a slanted lenticular lens whereby the resolution in the horizontal and vertical directions is the same. Using the same or different slant angle and attempting to increase the quantity of views results in a mismatch between the resolutions in the two directions.

This invention is directed at a method of generating large quantities of view sets, notably 18, 27 or more, with equal horizontal and vertical resolutions, producing a greater ‘look-around’ effect and providing a display with fewer transitions between sets of views and also a display with reduced Moiré patterns. To appreciate the method it is beneficial to understand the current technology.

LCD and plasma screens feature light-emitting elements that comprise red, green and blue rectangular elements, grouped in triplet sets adjacent each other to form pixels. Typically the individual colour elements, known as sub-pixels, are rectangular with an aspect ratio of 3:1 with a long axis in the vertical direction.

In auto-stereoscopic situations, adjacent sub-pixels can represent a ‘view’, of which there can be as few as two, for a simple single-viewer display or as many as nine or more views which allow greater latitude in the position of a viewer. A lenticular lens serves to image different views into each eye of an observer and hence deliver the illusion of depth to an image.

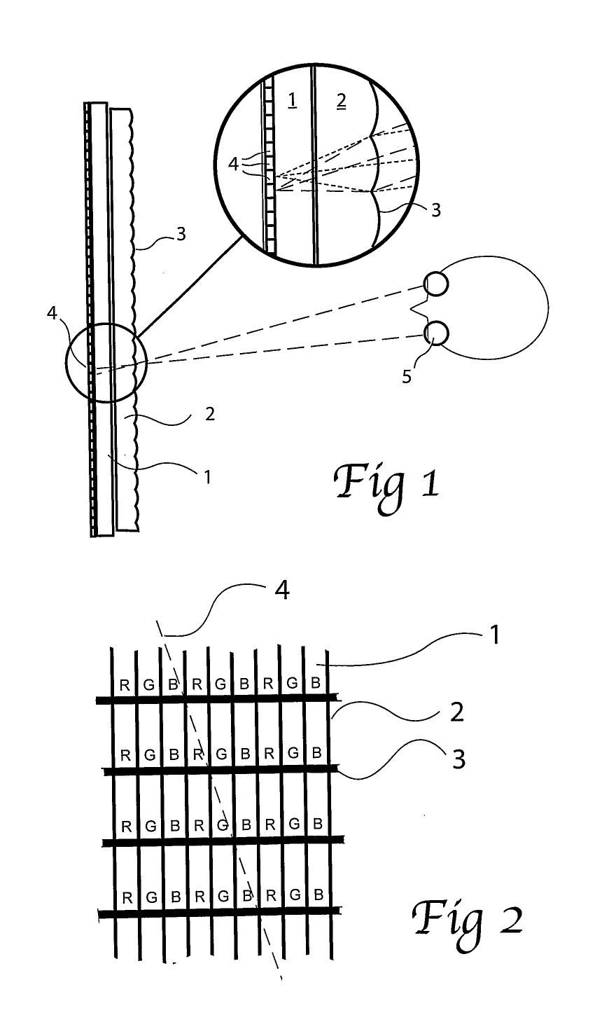

It is helpful to understand the technology with the aid of diagrams. FIG. 1, with an enlarged portion, shows the plan view geometry for an LCD display 1 having a slanted lenticular lens 2 comprising columns of cylindrical lens 3 also known as lenticles. Depending on the angle of view, different sub-pixels 4 will be seen, and at an optimum viewing distance, adjacent sub-pixels will be seen by different eyes 5. Ray paths are shown as dashed lines.

The schematic of a display as seen front-on is shown in FIG. 2. It shows red, green and blue sub-pixels 1, and the axis 4 of a lenticle is shown slanted in order to intersect red, green and blue sub-pixels. In a nine-view system the lens axis is inclined from the vertical by an angle of atan (⅓) which is about 18.5 degrees, and each lenticle spans 9 sub-pixels or 3 pixels.

The resolution in this optimised arrangement of 9 views is one third of an ‘un-lensed’ display. For example a 1920×1080 pixel display in effect becomes a 640×360 pixel display. Whilst seemingly low, such resolution is nevertheless adequate for most viewing applications.

It will be noted that in order to generate say 18 views, it could be achieved by doubling the pitch of the lenticles, however this would not result in a reduction of the vertical resolution which is also determined by the angle of the lenticular slant. The horizontal resolution of a display delivering 18 views would be reduced by a factor of 6. A display having a native 3840 pixels in the horizontal direction would deliver the same horizontal resolution as a nine-view lens applied to a native 1920 pixel display.

One of the drawbacks of ultra high-resolution displays is the demands for file sizes and data transfer rates when movie files are concerned. The present invention aims to provide a 3D auto-stereoscopic display with more than ten views and having equal resolution in the horizontal and vertical directions.

### Present Invention

The invention is said to reside in an auto-stereoscopic 3D display using a slanted lenticular lens coupled to a pixel-based display such as an LCD whereby it presents 9.n views where n is an integer greater than 1, characterised by the pixel output being duplicated in adjacent row sets of n pixel rows and the lenticular lens having a slant angle of atan (1/(3.n)) and a horizontal pitch of near 3.n.p where p is the pixel width.

The invention may also be said to reside in an auto-stereoscopic display comprising a lenticular lens sheet coupled to an LCD screen characterised by the lens having parallel cylindrical lenselets inclined near 9.5 degrees to vertical and having a horizontal pitch that is near 6 times the horizontal pitch of the LCD pixels, whereby the output from the LCD screen repeats on each alternate row of pixels.

With repetition of each second row, it may be seen that image file sizes can be reduced by approximately 1/n compared to images for which the output of each row is independent of others.

The invention also resides in a pixel-based display wherein the aspect ratio of the pixel triplets is 2:1 or 3:1 with the long axis in the vertical direction.

### DESCRIPTION

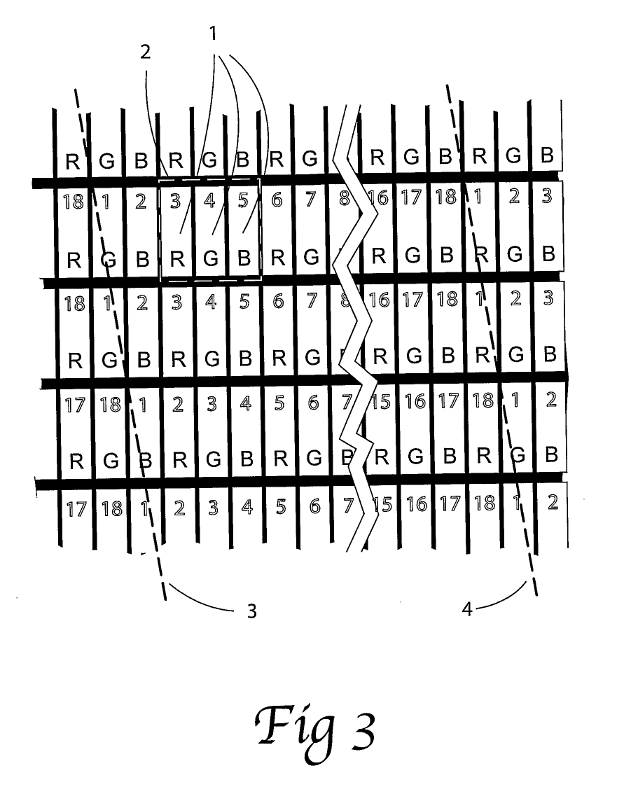

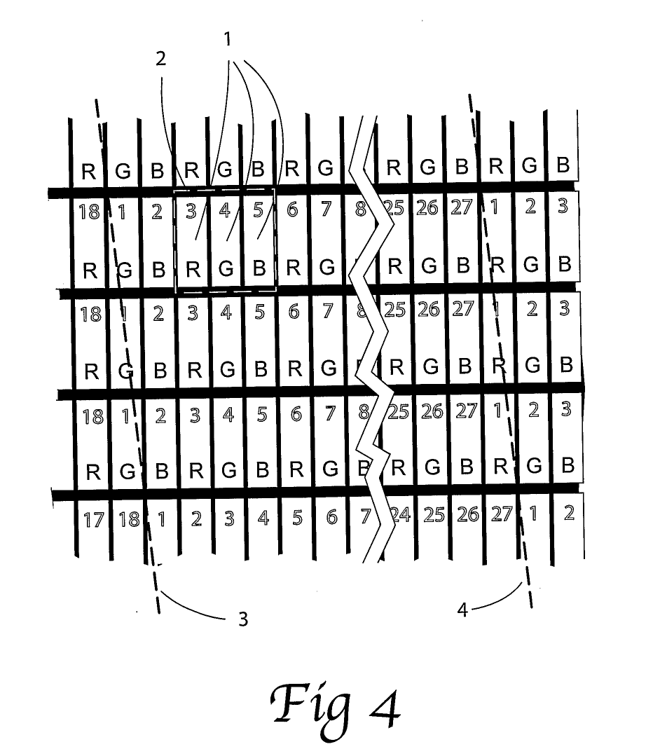

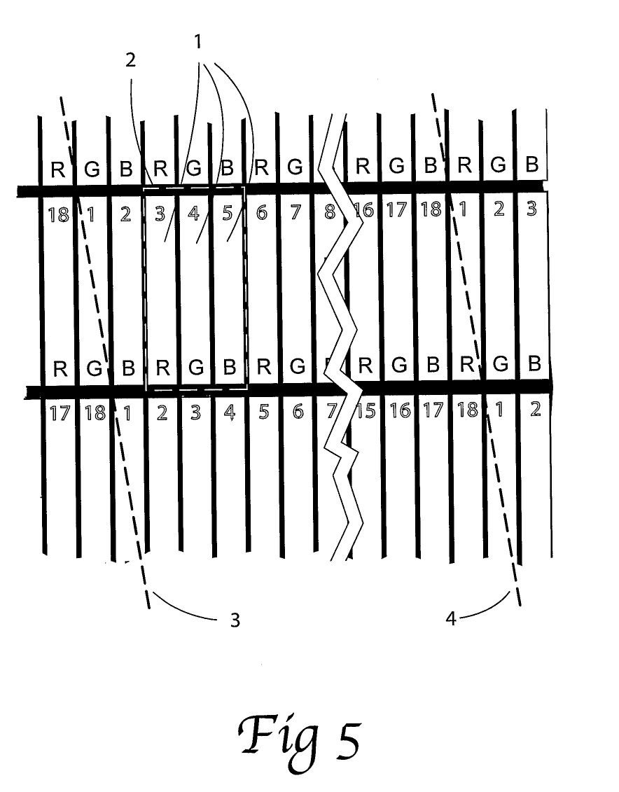

The invention can best be appreciated with reference to the accompanying figures which show a preferred embodiment. FIG. 3 shows a diagram of the arrangement for 18 views and FIG. 4 illustrates the arrangement for 27 views, whilst FIG. 5 shows a pixel geometry for achieving a similar result.

Referring to FIG. 3, an LCD display presents red, green and blue sub-pixels 1, a set of which constitutes a pixel as shown by outline 2 which is generally square. The numerals within each pixel refer to a relative view number and the R, G, B letters denote the colour of the sub-pixel. The axis of one cylindrical element of a lenticular lens is shown by the dashed line 3, and the axis of an adjacent element is shown by dashed line 4. The inclination of the axis is such that it can pass through two vertically adjacent sub-pixels. This angle corresponds to atan (⅙) which is approximately 9.46 degrees from vertical.

It can be seen that, say, a red component of a white image will repeat every sixth pixel in the vertical direction, and also every sixth pixel in the horizontal direction. Hence the resolution is preserved in both directions.

The input to the display is programmed such that every second row is repeated. With the use of a dedicated circuitry in the form of a chip, the image requires much less data than that of a full resolution image and should enable image file sizes to be near half the size of an equivalent full resolution image. The technology to produce the image data does not form part of the invention, but is considered rudimentary to someone in the computing field.

FIG. 4 shows a configuration for a 27-view display. Such quantity of views would only be suitable for displays that approach 10,000 pixels in the horizontal direction, the labels have the same meaning as for FIG. 2, with the difference being that the inclination of the axes 3 and 4 is such that they pass through three vertically adjacent sub-pixels. This angle corresponds to atan ( 1/9) which is approximately 6.34 degrees from vertical.

Although the above two descriptions refer to a single display panel of high definition, the principle can be applied to multiple displays of lower resolution tiled to produce large displays.

While the above descriptions refer to cylindrical lens, it refers to any optical element that serves to focus the light in one direction and includes holographic means and facetted surfaces. It also includes barrier or parallax filters.

An alternative version of the above embodiment is to provide a pixel geometry in which the sub-pixels have an aspect ratio of 6:1 rather than the conventional 3:1, and the input image could have a vertical resolution which is half that of a full resolution (3:1 sub-pixel aspect ratio) display.

FIG. 5 shows a pixel geometry which is designed to provide 18 views and not require doubling of outputs to pairs of rows. Referring to the figure, sub-pixels 1 have an aspect ratio which is near 6:1. A pixel boundary is indicated by 2, whilst the axes of a lenticular lens are shown as 3 and 4.

### EXAMPLES

A 45-inch (114 cm across diagonal) display with 3840 horizontal pixels and 2160 vertical pixels is employed to deliver auto-stereoscopic images using a lenticular lens for an optimum viewing distance of 3 metres. For an eye separation of 6.5 cm, the angular width of each view should be atan ( 6.5/300)=1.24°. For an 18-view display, the angular width of the 18 views would be about 22°. The normal desired viewing angle is about 30 degrees either side of the ‘straight on’ position, and so three sets of the 18 views would be required with two transition zones between them. This low number allows for much more comfortable viewing and the wider viewing angle between sets enables a greater 3D effect as a viewer can see further round edges of objects.

The above specified display would have a pixel size of 0.257 mm or a sub-pixel width of 0.0857 mm. So a lenticular lens would require a pitch in the horizontal direction of 0.257 mm×6=1.542 mm. This figure would in fact be reduced by a small factor to take into account the viewing distance, such that a particular view observed centrally will also be seen near the edges of the screen where the particular view will have to be directed inwards towards a viewer centrally positioned. The inclination of the axis of the lens is about 9.46 degrees, so the pitch in a direction normal to the lenticle axis can be calculated to be 1.521 mm.

The radius of the lenticles and the thickness of the lens depends on the width of any airspace which may be either intentionally near zero or a defined spacing such as 5 mm. Readily available optical software is available which can specify the radius and thickness of the lenticles based on the refractive index of the lens material—normally acrylic.

The lens is fabricated using conventional plastic forming technologies such as injection moulding, extrusion, hot-forming between rollers or hot-forming between plates in a press.

The content delivered to the display is suitably generated, divided into 18 views and spliced together. This aspect of the technology is not the subject of the invention.

Several content providers exist who have developed software for such auto-stereoscopic displays.

A second example features sixteen 45″ displays of pixel content 1920×1080. The displays are disposed closely together in a tiled fashion. To drive sixteen displays at full resolution would demand high file sizes and data transfer rates. By adopting principles of this invention, the file size can be substantially reduced by sacrificing resolution of each display by a factor of four in the vertical direction and including a lenticular lens that provides 36 views, so that the effective resolution of the collection of displays is 1920×1080. Although seemingly coarse for a large display with an effective size of 180″, when viewed from a distance such as 8 metres it would be quite acceptable.

It will be appreciated that the above described invention provides an improvement in the 3D experience using auto-stereoscopic displays, allowing for a large number of views and equal resolution in the horizontal and vertical axes.

1. An auto-stereoscopic display comprising a lenticular lens coupled to an LCD screen comprising an array of pixels, characterised by the lens having parallel cylindrical lenselets inclined near 9.5 degrees to a vertical axis and having a horizontal pitch that is near 6 times the horizontal pitch of the LCD pixels, whereby data input to each alternate rows of pixels is repeated on each adjacent row.

2. A lenticular lens for use with LCD screens, the lens having parallel cylindrical lenselets inclined near 9.5 degrees to a vertical axis.

3. A lenticular lens as in claim 2 whereby the horizontal pitch of the lens is near 6 times the horizontal width of the pixels of an LCD screen to which the lens is intended to couple.

4. A display as in claim 1 wherein the lens sheet is fabricated from acrylic.

5. An auto-stereoscopic display characterised by the inclusion of an electronic chip which serves to duplicate the signal to each output row of the display's LCD matrix, said display being coupled to a lenticular lens.

6. A slanted lenticular lens comprising cylindrical lenselets coupled to a pixel-based display such as an LCD whereby it presents sets of 9.n views where n is an integer greater than 1, characterised by the pixel output being duplicated in adjacent row sets of n pixel rows and the axis of the lenselets being inclined to vertical at an angle of atan(⅓n) and the horizontal pitch of the lenselets being 3n times greater than the width of the display pixels.
